(19) United States
(12) Patent Application Publication
(10) Pub. No.: US 2026/0370101 A1
(43) Pub. Date: Nov. 19, 2026

(54) ELECTRIC MOTOR WITH MITIGATION OF ELECTRICALLY INDUCED BEARING DAMAGE (EIBD)

(71) Applicant: Tesla, Inc., Austin, TX (US)

(72) Inventors: Antonios Chaniotis, Metamorfossi, Attiki (GR); Panagiotis Pouraimis, Acharnes (GR); Georgios Sakkas, Athens (GR); Iakovos Manolas, Agia Paraskevi (GR)

(21) Appl. No.: 19/121,779

(22) PCT Filed: Oct. 31, 2023
(86) PCT No.: PCT/US2023/036485

§ 371 Date: Apr. 16, 2025

Related U.S. Application Data
(60) Provisional application No. 63/381,914, filed on Nov. 1, 2022.

(51) Int. Cl. H02K 11/40; F16C 32/04; H02K 5/173

(52) U.S. Cl. CPC H02K 11/40; F16C 32/0474; H02K 5/1732; F16C 2380/26

(57) ABSTRACT

The present disclosure relates to an electric motor assembly configured to mitigate Electrically Induced Bearing Damage (EIBD). More specifically, the electric motor assembly includes a chassis, a stator, a winding coil, a rotor, a shaft, a conductor, a circuitry, and an insulator. The circuitry can include one or more transformers that can generate injected voltage, and the injected voltage can mitigate shaft voltage that causes the EIBD.

### CROSS-REFERENCE TO RELATED APPLICATION

This application claims priority to U.S. Provisional Patent Application No. 63/381,914 titled “ROTOR VOLTAGE CANCELLATION” and filed on Nov. 1, 2022, the disclosure of which is hereby incorporated herein by reference in its entirety.

### TECHNICAL FIELD

Embodiments of the present disclosure relate to an electric motor. More specifically, embodiments of the present disclosure relate to systems and methods for mitigating Electrically Induced Bearing Damage (EIBD) caused within the electric motor.

### BACKGROUND

Electric motors have a wide range of applications, including their use in various types of vehicles such as electric, combustion engine, and hybrid vehicles. These motors function by converting electrical energy into mechanical energy. This conversion process involves applying electricity to the motor, which then generates magnetic fields in two key components—the stator (a static component) and the rotor (a rotating component). The interaction between the magnetic fields of the stator and rotor produces mechanical energy, causing the rotor to rotate. Typically, an electric motor is supplied with alternating current (AC) in multiple phases, each generating a magnetic field with a different phase. The AC is generated from an inverter, such as the switching inverter. For example, the inverter receives direct current (DC) from an external power source, such as a battery, and converts the DC into the AC by switching the DC (e.g., turning on or off the DC) in various frequencies. Thus, the switching mechanism of the inverter can generate AC waveforms in various frequencies and phases, and the speed of electric motor rotation (e.g., rotor rotation) can be modulated by adjusting the frequency of the supplied AC.

Examples of electric motor applications can include, but are not limited to, electric vehicles, electric pumps, electric fans, robotic systems, etc.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is an electric motor assembly that includes a chassis, a stator configured to receive energy from external energy sources, a winding coil configured to generate magnetic field, wherein the winding coil is implemented within the stator, a rotor magnetically coupled with the stator, a shaft connected with the rotor, bearings connected between the shaft and the chassis, a conductor capacitively coupled with the rotor, a circuitry configured to generate an injected voltage, wherein the circuitry is connected with the winding coil and the conductor, and an insulator connected between the conductor and the chassis.

In the electric motor assembly, the rotor is rotating by the magnetic field generated from the winding coil.

In the electric motor assembly, the energy can be received from an inverter that can supply an alternating current to the electric motor assembly, and the alternating current can include three waveforms with a same frequency. In addition, each waveform can have 120-degree different phase.

In the electric motor assembly, the circuitry can include a transformer, The transformer can generate injected energy by receiving inducing current from a neutral point of the winding coil.

In the electric motor assembly, the electric motor can include parasitic capacitances between the chassis and winding coil, the winding coil and the rotor, the stator and the rotor, and across the bearing. The common mode voltage can generate a shaft voltage between the shaft and the chassis. The shaft voltage can be mitigated by the injected voltage.

In the electric motor assembly, the circuitry can include a first transformer, a second transformer, a low-pass filter, and a high-pass filter. The first transformer can transfer high-frequency band signal by receiving an energy from the conductor and filtering the energy via the high-pass filter. The second transformer can transform low-frequency band signal by receiving the energy from a neutral point of the winding coil and filtering the energy via the low-pass filter.

In the electric motor assembly, the electric motor assembly can be implemented in an electric vehicle.

Another aspect of this disclosure is an electric motor assembly that includes a chassis, a stator configured to receive energy from external energy sources, a winding coil configured to generate magnetic field, wherein the winding coil is implemented within the stator, a rotor magnetically coupled with the stator, a shaft connected with the rotor, bearings connected between the shaft and the chassis, a conductor capacitively coupled with the rotor, a transformer configured to generate an injected voltage, and the transformer is connected with the winding coil and the conductor, and an insulator connected between the conductor and the chassis.

In the electric motor assembly, the transformer can be integrated in a top side of a printed circuit board (PCB), and the conductor can be integrated a bottom side of the PCB. Additionally, the transformer can receive energy from a neutral point of the winding coil.

In the electric motor assembly, the electric motor can include parasitic capacitances between the chassis and winding coil, the winding coil and the rotor, the stator and the rotor, and across the bearing, and the shaft voltage can be generated from one or more of the parasitic capacitances. Additionally, the shaft voltage can be mitigated by the injected voltage.

In the electric motor assembly, the rotor can be rotating based on switching frequency of an inverter. The inverter can supply AC to the electric motor assembly.

In the electric motor assembly, the received energy can be an alternating current, and the alternating current can include three waveforms with a same frequency. Additionally, each waveform can have 120-degree different phase. Furthermore, the frequency can be a switching frequency of an inverter configured to supply AC to the electric motor assembly.

In the electric motor assembly, the transformer can be connected to a neutral point of the winding coil.

In the electric motor assembly, a distance between the conductor and the rotor can be determined based on parasitic capacitances.

Another aspect of this disclosure is a method of mitigating EIBD of an electric motor. The method includes initiating operation of the electric motor, wherein the electric motor is initiated by receiving input at a neutral point of the electric motor, generating a common mode voltage; generating a shaft voltage, wherein the shaft voltage is a fraction of the common mode voltage; and generating injected voltage to mitigate the shaft voltage, wherein the injected voltage is generated from a transformer connected between a neutral point and a conductor of the electric motor, wherein an input of the transformer receives input signal from the neutral point, wherein an output of the transformer is connected to the conductor placed apart from a rotor, and the input and output of the transformers have opposite polarity.

Another aspect of this disclosure is a circuitry to mitigate an EIBD of an electrical machinery. The circuitry includes a PCB board, a transformer integrated on the top of the PCB board, wherein the transformer is configured to generate injected voltage, an input configured to provide input voltage to the transformer, wherein the input is received from a neutral point of the electrical machinery, and an output of the transformer connected to a conductor of the circuitry, wherein the conductor is implemented in a bottom of the PCB board, and wherein the output and the conductor are connected through a via of the PCB board. The electrical machinery can be an electric motor of an electric vehicle. The output can mitigate voltage generated by parasitic capacitances of the electrical machinery

For purposes of summarizing the disclosure, certain aspects, advantages, and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 illustrates an example of a cutaway view depicting an embodiment of an electric motor in accordance with one or more aspects of the present application;

FIG. 2A depicts a 2-dimensional view of a traditional electric motor;

FIG. 2B illustrates a schematic diagram of the traditional electric motor;

FIG. 3A depicts a 2-dimensional view of an electric motor in accordance with one or more aspects of the present application;

FIG. 3B illustrates a schematic diagram of the electric motor in accordance with one or more aspects of the present application;

FIG. 4A illustrates a rotor voltage corresponding to the traditional electric motor operation,

FIG. 4B illustrates a rotor voltage corresponding to the one or more aspects of the present application;

FIG. 5 illustrates an example of a circuitry with a smaller form factor;

FIG. 6 illustrates an example of a flow chart for implementing a circuitry to mitigate shaft voltage in accordance with one or more aspects of the present application;

FIGS. 7A-7C illustrate an example method for determining parasitic capacitances of the electric motor; and

FIG. 8 illustrates an example of operating an electrical motor by implementing circuitry to substantially reduce (e.g., substantially minimize) shaft voltage in accordance with one or more aspects of the present application.

### DETAILED DESCRIPTION

Although certain preferred embodiments and examples are disclosed below, the inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations, in turn, in a manner that may be helpful in understanding certain embodiments; however, the order of description should not be construed to imply that these operations are order-dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

As the demand for electric motors is increasing, there's a growing interest in developing motors that can operate with a substantial lifespan. Thus, reducing the wear and tear on components is critical. For example, electric motors that leverage magnetic fields between the stator and rotor could potentially minimize wear and tear. This is because these two components do not come into physical contact, thereby eliminating friction between them.

However, the operation of the electric motor can generate electrically induced bearing damage (EIBD). More specifically, the electric motor can receive energy (e.g., AC) from an inverter (e.g., switching inverter). The inverter is configured to convert DC to AC, and the AC is utilized as an energy source for the electric motor. The inverter can generate the AC by performing a switching operation. Typical steel bearings experience premature wear when they are fitted in an electrical machine fed by the switching inverter. This is caused by the common mode voltage, which is inherent to the switching inverter operation, and is partially captured by the rotor, because some part of the rotor is exposed to the windings bearing the inverter voltage. Electrically Induced Bearing Damage (EIBD) happens when the rotor (and subsequently shaft) voltage rises above about a threshold voltage, such as 3.5V with respect to the machine frame (usually same as ground). Under such conditions, the thin insulative lubricant film on the bearing balls may break down and an arc may form. Thus, the accumulated charge may discharge on the rotor through a substantially confined spot between a bearing ball and a race creating a tiny weld, essentially initiating Electrical Discharge Machining (EDM). This weld is subsequently pulled as the bearing runs and a deformation now exists in both ball and race surfaces. The process is repeated in each switching cycle in a random way. The phenomenon is more intense when the DC voltage connected to the inverter is high, as well as when the switching frequency is high and happens because all parts of the circuit are in essence interconnected through parasitic capacitance. Parasitic capacitance means a capacitance that forms between two conductors, even when there was not such intention from the designer.

Traditionally, to decrease or minimize the electrical bearing damage, the rotor may be physically grounded, allowing currents generated by parasitic capacitances to flow to the ground instead of flowing into the bearings through the rotor and shaft. For instance, the rotor and the chassis of the electric motor (which serves as the electric motor's ground) are electrically connected using conductive ball bearings between the rotor and stator. In another method, a conductive brush is used around the shaft, establishing electrical contact with the motor's chassis. However, these conventional methods lead to technical limitations due to the inconsistent nature of the conductive compound inside the bearings. Furthermore, implementing the brush can limit the operational life of the electric motor dependent on the life of the brush. For example, the brush is in physical contact with one or more components of the electric motor, thereby causing unwanted wear and tear issues on the brush due to the physical contact (e.g., friction between components). Other traditional methods, such as using insulated bearings or choke, also have technical limitations and do not address the root cause of generating unwanted voltages due to parasitic capacitances.

This present disclosure provides technical solutions to mitigate the EIBD. More specifically, the present disclosure provides methods to mitigate the unwanted voltages generated during the operation of electric device applications, such as the electric motor. Additionally, the technical solutions provided herein resolve the root cause of the EIBD by minimizing or mitigating the unwanted voltages without implementing hardware that requires wear and tear of the components of the electric motor.

In some aspects of the present disclosure, the electric motor can include electrical circuitry that can generate voltages (e.g., injected voltages) to mitigate the unwanted voltage. For example, a common mode voltage, generated by the switching operation of an inverter that provides the energy to the electric motor can lead to unwanted voltage on the shaft of the electric motor (shaft voltage). In some examples, the electrical circuitry can generate the injected voltages having opposite polarity with respect to the shaft voltage (e.g., the unwanted voltage that causes the EIBD). For instance, when the shaft voltage reaches positive voltage, the injected voltage can reach negative voltage with the same or similar absolute amount of the shaft voltage. Moreover, when the shaft voltage reaches negative values, the injected voltage can reach positive values of the same absolute value as the shaft voltage. In some embodiments, the injected voltage can be generated to keep the shaft voltage below a threshold voltage that causes the EIBD, such as the threshold voltage of about 3.5V. As a result, the shaft voltage can be reduced to zero, near zero, or below the threshold voltage. This helps in minimizing or completely eliminating electrical bearing damage.

In some embodiments of the present disclosure, one or more transformers are used as the source of the injected voltage. For illustration, a conductor plate is capacitively coupled with the rotor, and the transformer receives its energy source through a conductive coupling with the winding neutral (e.g., winding neutral point of the winding coil) and the ground (e.g., chassis of electric motor). For instance, when the electric motor is operating, the conductor and rotor can be capacitively coupled. As a result, the energy source of the transformer can be the connection between the winding neutral point of the winding coil and the ground source (e.g., the chassis of the electric motor). By utilizing this energy source, the transformer generates the injected voltage that can be utilized to mitigate the shaft voltage.

One or more aspects of the present disclosure are related to methods for mitigating the EIBD by minimizing or eliminating the shaft voltage. In some embodiments, the method can include determining the parasitic capacitances of the electric motor. As disclosed herein, the parasitic capacitances are generated due to the capacitive coupling between components of the electric motor. After determining the parasitic capacitances, the present disclosure provides a method of implementing the transformer and conductor. More specifically, the present disclosure provides methods for determining the size of the conductor, the parameters of the transformer, and the distance between the conductor and the rotor. In some embodiments, the transformer and conductor are implemented in a printed circuit board (PCB). For example, one side of the PCB can implement conductive material, and the opposite side of the conductive material can implement the transformer. In this example, the conductive material is capacitively coupled with the rotor and serves as a conductor. Further, in this example, the transformer and the conductive material are connected by via, so the transformer can transmit energy to the conductive material from the via connection.

Some aspects of the present disclosure provide various transformer designs that can be implemented in the electric motor. In some embodiments, the size of the transformer can be minimized by utilizing more than one transformer alongside various filters (e.g., low pass filter and high pass filter). For instance, two transformers can be implemented in the same circuit, with one transformer used for high-frequency energy signals and the other for low-frequency signals. This approach has the advantage of minimizing the size of the transformer circuitry. For example, a single transformer that can cover both high and low frequencies might have a large form factor and may not be feasible to implement into the electric motor. However, using multiple transformers can reduce the form factor of the transformer circuitry.

Although the various aspects will be described in accordance with illustrative embodiments and a combination of features, one skilled in the relevant art will appreciate that the examples and combination of features are illustrative in nature and should not be construed as limiting. More specifically, aspects of the present application may be applicable to various types of applications, and each application may require a different specification of the electric motor. For example, the specification of the electric motor used for fan is different from the specification of the electric motor used for electric vehicle. Accordingly, the illustrative examples should not be construed as limiting.

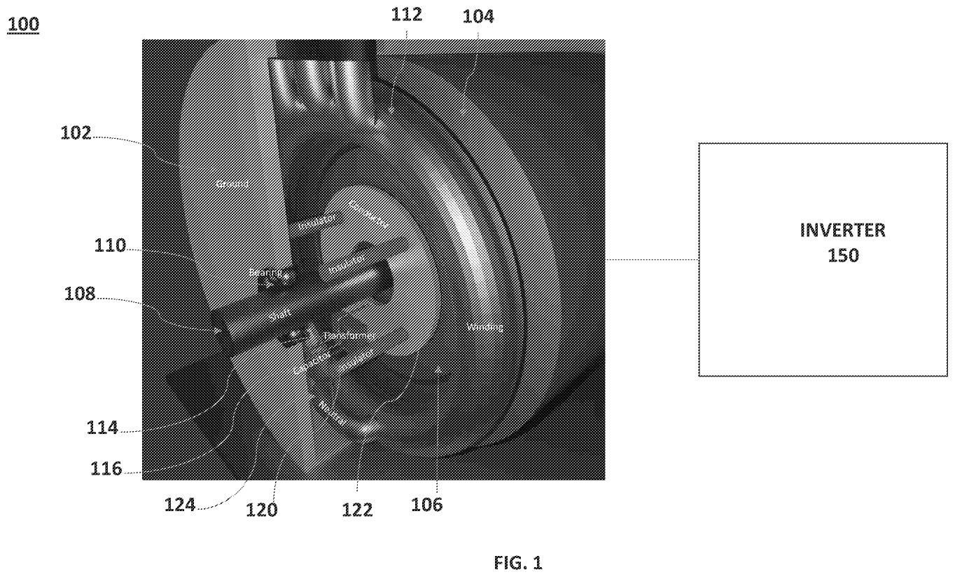

FIG. 1 illustrates an example of a cutaway view depicting an embodiment of an electric motor, as disclosed herein. As illustrated in FIG. 1, the electric motor can be assembled with a chassis 102 that can include a stator 104, a rotor 106, a shaft 108, and bearings 110. The stator 104 can include a winding coil 112. In some embodiments, alternating currents (AC) can be applied to the winding coil 112 included in the stator 104, and the winding coil 112 can generate a magnetic field due to the received AC. In some embodiments, the AC is provided as multiple-phase waveforms. For example, if there are three phases, the magnetic field generated on the winding coil can include 3 different magnetic fields, and each magnetic field corresponds to each phase. In some examples, the AC can be provided from external power sources, such as an inverter that connects to battery, power outlet, and the like. In some embodiments, the electric motor is connected to an inverter 150. For example, the inverter 150 is configured to supply the AC to the electric motor by connecting with a grounding source, such as the chassis 102. The inverter 150 can be configured to generate the required AC by converting DC received from an external source, such as a power outlet, battery, and the like. The inverter 150 can be configured to generate AC waveforms with multiple different phases, such as 3 phases, that each waveform has 120 degree phase difference (at a same frequency). In addition, the switching frequency of the inverter can be correlated with the frequency of the waveforms. In some examples, the frequency of the inverter is proportionally correlated with the rotation speed of the rotor 106 and the shaft 108.

The applied voltages can generate currents. The currents can generate magnetic fields. These magnetic fields can generate a rotating magnetic field based on the different phases. This rotating magnetic field can induce current on the rotor 106, and the rotor 106 can be rotated due to the rotating magnetic field. In some embodiments, the shaft 108 can be assembled with the rotor 106 and rotating the rotor 106 can cause rotation of the shaft 108, As further described in FIG. 1, the shaft 108 and the chassis 102 are assembled with the bearings 110.

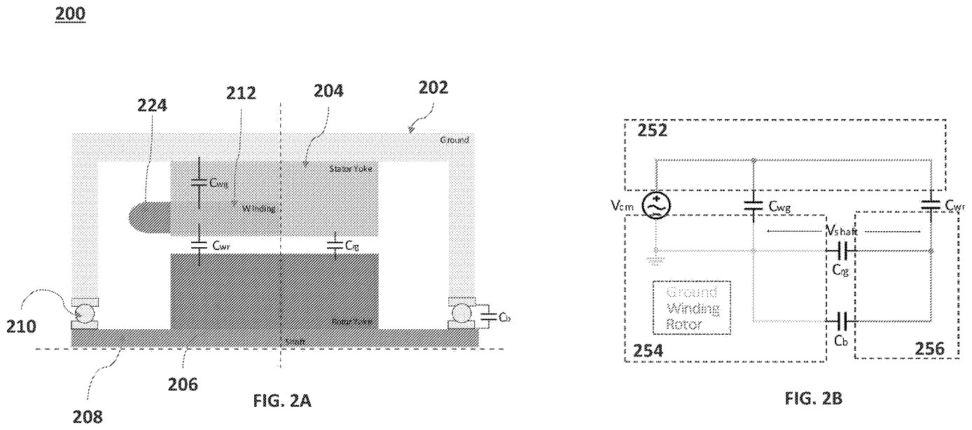

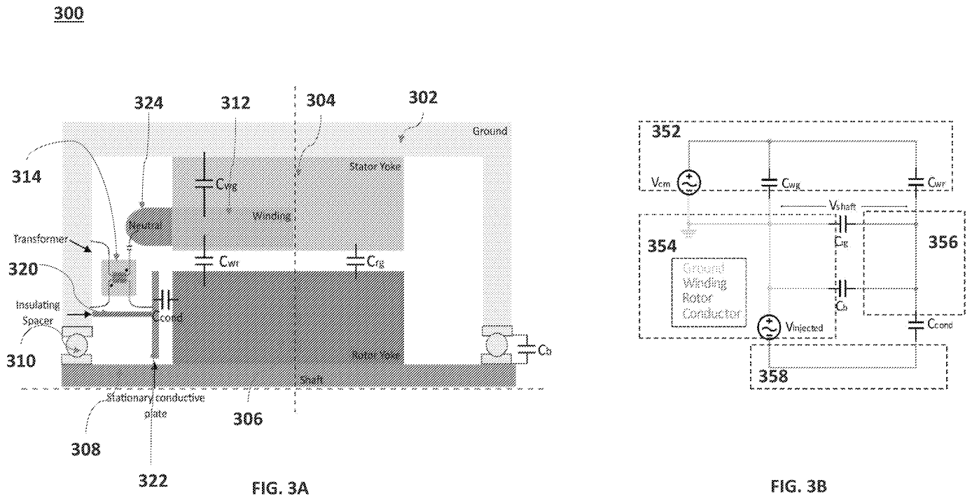

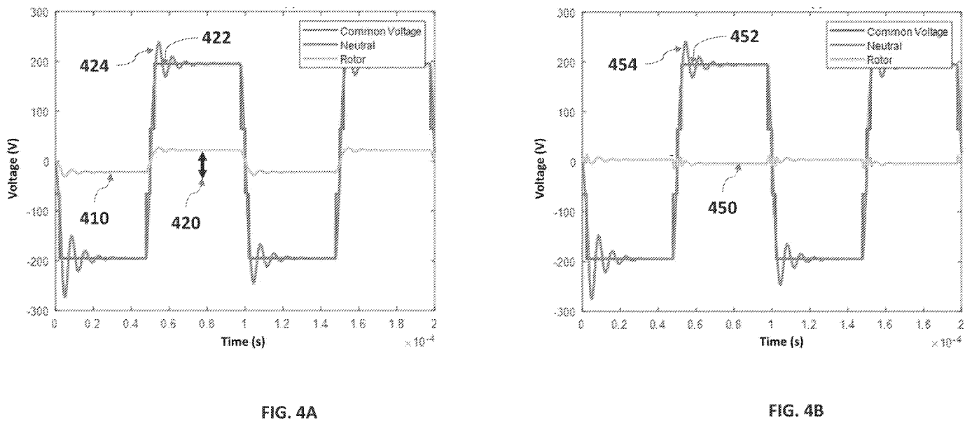

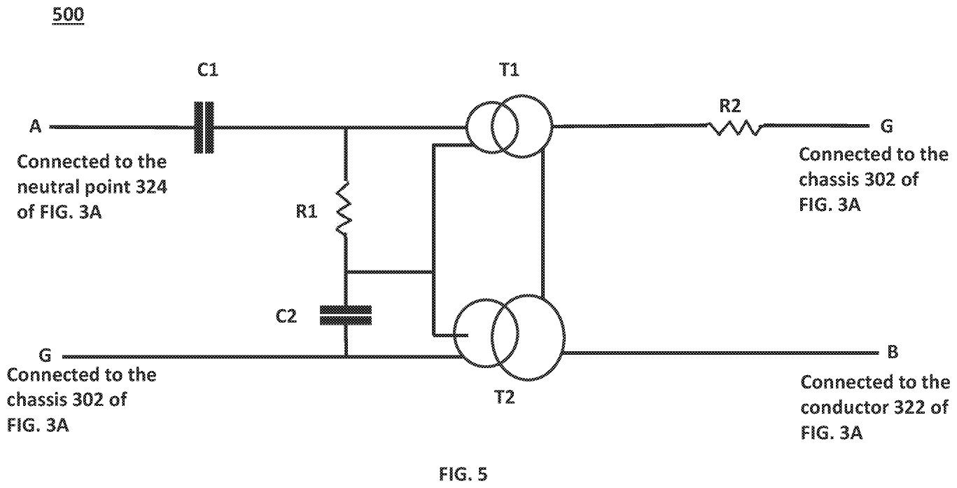

The electric motor 100 can additionally include a transformer 114, a capacitor 116, insulators 120, and a conductor 122. These additional components can be utilized to mitigate the EIBD, as disclosed herein. For example, the transformer 114 is connected between the winding neutral point 124 and the conductor 122. Without being constrained by way of theory, the neutral can act as a source with respect to ground as sources (e.g., battery, power outlet, and so on) may be capacitively coupled to ground by the parasitic capacitances inherent between physical conductor bodies. In some examples, the conductor 122 and the rotor 106 are capacitively coupled during the operation of the electric motor 100 (e.g., while the rotor 106 is rotating). In some examples, the transformer 114 can generate injected voltage to mitigate the shaft voltage (e.g., voltage between the shaft 108 and chassis 102) and induce current via the conductor 122 to the rotor 106. This injected voltage can mitigate the shaft voltage, Vshaft (shown in FIG. 2B and FIG. 3B). A detailed description of mitigating the shaft voltage will be described below.

As further described in FIG. 1, since the rotor 106 and shaft 108 are rotating by inducing the rotating magnetic field generated from the winding coil 112, these components are not physically contacted. Thus, the electric motor 100 can be a permanent magnet electric motor.

The electric motor 100 can be applied to an electric vehicle. However, the present disclosure does not limit the application of the electric motor 100, and it can be applied to any suitable application.

FIGS. 2A and 2B are illustrating 2-dimensional view of a traditional electric motor 200. As shown in FIG. 2A, the traditional electric motor 200 can be assembled with a chassis 202 that can include a stator 204, a rotor 206, a shaft 208, and bearings 210. The stator 204 can include a winding coil 212. As shown in FIG. 2A, during the operation of the electric motor 200, parasitic capacitances exist between two components. For example, when power is applied to the electric motor 200 (e.g., power is applied from an inverter), the DC supplied to the inverter can cause the common mode voltage between the winding coil 212 (e.g., winding neutral point of the winding coil) and the ground (e.g., the chassis 202). This common mode voltage can charge the parasitic capacitances, Cwg, Cwr, Crg, and Cb shown in FIG. 2A. For example, the common mode voltage can charge the parasitic capacitive coupling, Cwg, between the winding coil 212 and the chassis 202. The common mode voltage can also charge the parasitic capacitive coupling, Cwr, between the winding coil 212 and the rotor 206. In addition, the common mode voltage can charge the parasitic capacitive coupling, Crg, between the rotor 206 and the chassis 202 (e.g., the stator 204 is physically in contact with the chassis). In some embodiments, Crg is related to the inducing current from the stator to the rotor. Furthermore, as shown in FIG. 2B, Crg and Cb are connected in parallel and connected with Cwr in series. Thus, a higher value of the Crg can result in lower shaft voltage, Vshaft. In some embodiments, voltage can be induced on the shaft 208 due to the induced current on the rotor 206 by charging the Cwr and Crg. This induced voltage can charge the parasitic capacitive coupling, Cb, between the chassis 202 and the shaft 208. These parasitic capacitive couplings, Cwg, Cwr, Crg, and Cb, can generate unwanted voltage across the shaft, Vshaft, and the Vshaft can cause damage to the bearings 210. This damage is generally referred to as EIBD.

FIG. 2B illustrates a schematic diagram of FIG. 2A. As shown in FIG. 2B, the section 252 corresponds to the winding coil 212, and the section 254 corresponds to the chassis 202. Additionally, the section 256 corresponds to the rotor 206. During the operation of the electric motor 200, the voltage applied to the winding neutral point 224 from the inverter 150 shown in FIG. 1 can generate the common mode voltage, Vem. A portion of the common mode voltage, Vem, can generate the shaft voltage, Vshaft, due to the parasitic capacitances, as shown in FIG. 2B.

To mitigate the shaft voltage, Vshaft, generated by the parasitic capacitances, the present disclosure provides an electric motor 300 by implementing additional circuitry, conductor, and insulator, as described in FIG. 3A. FIG. 3A illustrates a 2-dimensional view of the electric motor depicted in FIG. 1.

As depicted in FIG. 3A, the chassis 302 of the electric motor 300 can be assembled with the stator 304, the rotor 306, the shaft 308, the bearings 310, and the winding coil 312. Additionally, the electric motor 300 can include the transformer 314, the insulator 320, and the conductor 322. In some embodiments, the transformer 314 can be configured to generate the injected voltage. The injected voltage can be configured to mitigate the shaft voltage, such as the injected voltage has opposite polarity from the shaft voltage, thus, the shaft voltage can be mitigated. For example, during the operation of the rotor 306 (e.g., during rotating the rotor), the conductor 322 can be capacitively coupled (e.g., capacitive coupling, Ccond) with the rotor 306. For instance, the rotor 306, during its rotation, can generate an electric field that can be coupled with the conductor 322. The amount of capacitance of the Ccond can be determined based at least on the distance between the conductor 322 and the rotor 306. In some examples, the transformer 314 can receive input from the winding neutral point 324 and transform the input to the output between the conductor 322 and the chassis 302. In some embodiments, the output voltage can have opposite polarity with respect to the input voltage polarity. By utilizing this input power source, the transformer 314 can generate injected voltage (e.g., the output voltage). In some examples, the injected voltage, Vinjected (output of the transformer 314), can charge the Ccond, capacitance existing between the conductor 322 and the rotor 306. The induced current due to the Vinjected can flow via the Ccond, and this current and the Ccond can generate voltage drop across the Ccond. Thus, in some embodiments, the Ccond can be related to the Crg, thus, the shaft voltage, Vshaft, can be reduced. In some examples, the distance between the conductor 322 and the rotor 306 determines the amount of current flowing through the Ccond, the distance can be determined based on the Vshaft.

In some instances, the transformer 314 can be implemented as a circuitry. For example, the transformer 314 can be integrated with a PCB and connected with the winding neutral 324 of the winding coil 312 and the chassis 302. In some cases, the circuitry can include additional passive electrical components, such as resistor(s) and/or capacitor(s). These electrical components can be determined based on the required output of the transformer. For example, if the transformer 314 is configured to operate in certain frequency bands, one or more of these electrical components can be implemented to function as a frequency filter (e.g., high pass filter or low pass filter). In some examples, the circuitry can include the transformer 314 and also the conductor 322. For example, one side of the PCB can include the conductor 322 layer, and the other side of the PCB can include the transformer 314. The electric motor 300 can also include the insulator 320.

FIG. 3B illustrates a schematic diagram of FIG. 3A. As shown in FIG. 3B, the section 352 corresponds to the winding coil 312, and the section 354 corresponds to the chassis 302. Additionally, the section 356 corresponds to the rotor 306. Furthermore, the section 358 corresponds to the conductor 322. As depicted in FIG. 3B, the transformer 314 can generate the injected voltage, Vinjected. The injected voltage, Vinjected, has an opposite polarity to the common mode voltage, Vom. Thus, the shaft voltage, Vshaft, can be canceled out (e.g., mitigated) by applying the injected voltage, Vinjected. In some embodiments, the amount of injected voltage, Vinjected, can be adjusted based on the value of the Ccond. Thus, the distance between the conductor 322 and the rotor 306 can be determined based on the amount of the common mode voltage, Vem, and the shaft voltage, Vshaft. For example, the capacitance of the Ccond has an inversely proportional relationship with the distance between the conductor 322 and the rotor 306.

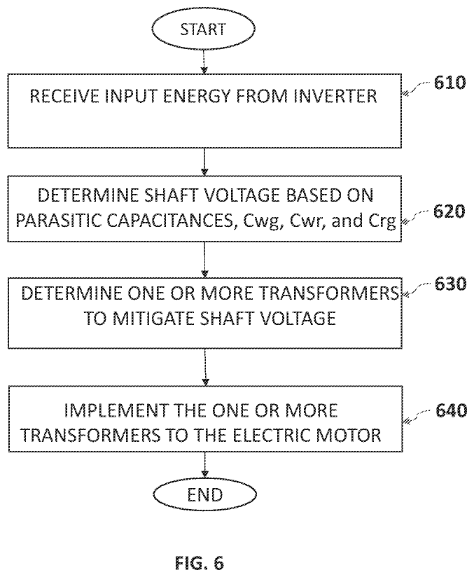

FIGS. 4A and 4B illustrate an example of a comparison of the shaft voltage, Vshaft 420 (e.g., voltage between rotor and chassis because the rotor and shaft are conductively coupled) during the operation of the electric motor. FIG. 4A corresponds to the operation of the electric motor 200 illustrated in FIGS. 2A and 2B. As shown in FIG. 4A, a fraction of the common mode voltage 422, Vem, is induced on the rotor, such as the shaft voltage (Vshaft). For example, the common mode voltage 422, Vom, is generated by the inverter (150) and averaged out on the winding neutral point 224 (shown in FIG. 2A), so FIG. 4A illustrates a similar pattern between the common mode voltage 422, Vem, and the winding neutral point voltage 424 (e.g., the voltage emerging on the winding neutral 224 of FIG. 2A). The electric motor 200 does not include the transformer utilized to mitigate the shaft voltage, Vshaft. Thus, as shown in FIG. 4A, the voltage 410 generated at the rotor 206 can have the shaft voltage, Vshaft, of 420. This shaft voltage, Vshaft, can cause the EIBD.

FIG. 4B corresponds to the operation of the electric motor 300 illustrated in FIGS. 3A and 3B. As described in FIG. 4B, there is a common mode voltage 452, Vem, generated from the DC inverter (e.g., power source) connected to the electric motor 300 (shown in FIG. 3A). In addition, the common mode voltage 452, Vom, can have the similar pattern with the winding neutral point voltage 454 (e.g., voltage emerging on the winding neutral point 324 of FIG. 3A from the inverter). As shown in FIG. 4B, the shaft voltage 450, Vshaft, caused by the common mode voltage 452, Vom, is mitigated by the injected voltage, Vinjected, as shown in FIG. 3B. Thus, as shown in FIG. 4B, the shaft voltage 450, Vshaft (e.g., the voltage at the rotor) can be near zero. In some embodiments, this voltage can be at or below the threshold voltage, such as the voltage that can cause the EIBD.

In some embodiments, the transformer 314 can be designed to operate in a wide frequency range. For example, the bandwidth of the frequency range can be tens of kHz to hundreds of MHz. This frequency range can be determined based on the switching frequency of the inverter. In some embodiments, the transformer 314 designed to operate in a wide frequency range can have a larger form factor. Thus, in some applications where the size of the electric motor is limited, the smaller form factor of the transformer 314 is desirable. The inverter's switching frequency can be determined based on specific applications, and the present disclosure does not limit the frequency range.

FIG. 5 illustrates an example of a circuitry 500 with a smaller form factor. As shown in FIG. 5, the circuitry 500 can include two transformers, T1 and T2. Each transformer can be configured to operate in a certain frequency band, thus, the combined size of the T1 and T2 can be smaller than a single transformer that can be operated in the wide frequency range. The circuitry can receive input by connecting the point A to the winding neutral point 324 (shown in FIG. 3A) and the point G to the chassis 302. The output of the circuitry 500 can correspond to the point G connected to the chassis 302, and the point B connected to the conductor 322. Thus, the output voltage of the circuitry can generate opposite voltage in respect to the input voltage. Additionally, the circuitry 500 can include a combination of a low-pass filter and a high-pass filter. Thus, the input signal (generated at between point A and point G) can be filtered and supplied to one of the transformers T1 or T2 based on its frequency. For example, T2 can have a higher number of transformer coils than T1 and is configured to transform low-frequency band signal, and the T1 can be configured to transform high-frequency band signal. In this example, the combination of C1 and R1 can filter the low-frequency band of the input signal and supply the filtered signal to the T1. Also, the combination of R1 and C2 can filter the high-frequency band of the input signal and supply the filtered signal to the T2. R2 can be implemented as an output load to generate the output voltage between point B and point G. Therefore, the form factor of the transformer can be minimized by utilizing multiple small-size transformers and a combination of frequency filters. The present disclosure does not limit the value of the C1, C2, R1, R2, T1, and T2, and these values can be determined based on specific applications.

FIG. 6 illustrates an example of implementing one or more transformers to the electric motor assembly to mitigate the shaft voltage. FIG. 6 is described by referencing FIG. 1, FIGS. 2A and 2B, FIGS. 3A and 3B, and FIGS. 7A-7C.

At block 610, the electric motor receives input energy from an inverter, such as inverter 150 shown in FIG. 1. In some embodiments, alternating currents (AC) can be applied to the winding coil 112 included in the stator 104, and the winding coil 112 can generate a magnetic field due to the received AC. The AC is generated from an inverter, such as the switching inverter. For example, the inverter receives direct current (DC) from an external power source, such as a battery, and converts the DC into the AC by switching the DC (e.g., turning on or off the DC) in various frequencies. Thus, the switching mechanism of the inverter can generate AC waveforms in various frequencies and phases, and the speed of electric motor rotation (e.g., rotor rotation) can be modulated by adjusting the frequency of the supplied AC.

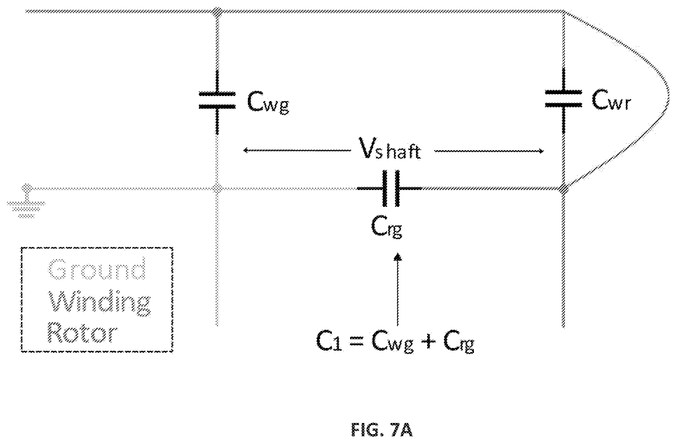

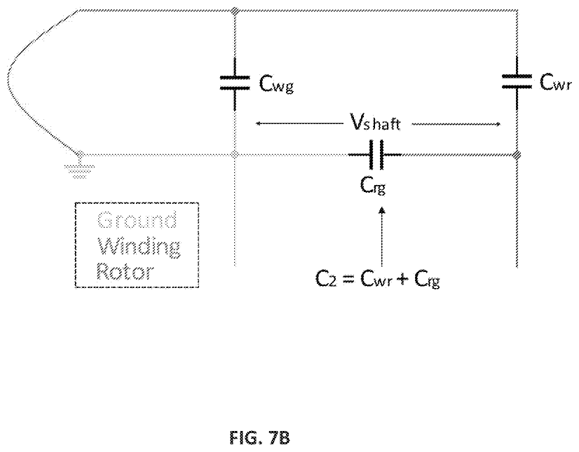

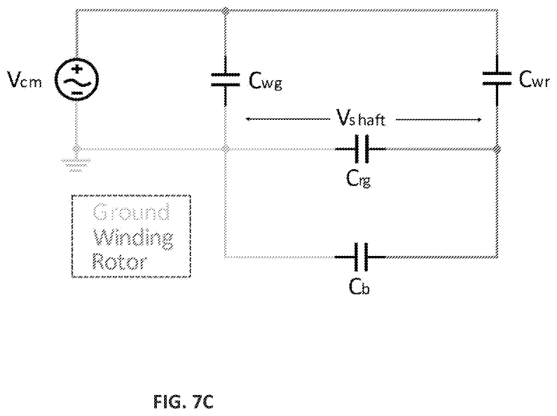

At block 620, the shaft voltage can be determined by measuring the parasitic capacitances, Cwg, Cwr, and Crg. These capacitances can vary based on the specific applications, and the person with ordinary skill in the art can measure these capacitances. For example, as illustrated in FIG. 7A, the total capacitance, C1, can be measured, and C1 can represent the combined capacitance of Cwg and Crg. Then, as illustrated in FIG. 7B, the total capacitance, C2 can be measured, and C2 can represent the combined capacitance of Cwr and Crg. The shaft voltage can be measured based on the measured common mode voltage, Vem, and the capacitances at FIGS. 7A and 7B.

At block 630, the electric motor determines one or more transformers to mitigate the shaft voltage. In some embodiments, the transformer 314 can be configured to generate the injected voltage, as shown in FIG. 3B. The injected voltage can be configured to mitigate the shaft voltage, such as the injected voltage having opposite polarity from the shaft voltage, thus, the shaft voltage can be mitigated. The transformer can be designed based on this required injected voltage. In some embodiments, a single transformer can be implemented to generate the injected voltage. In some embodiments, multiple transformers can be implemented to reduce the form factor having a wide bandwidth. The example of implementing two transformers is described in FIG. 5.

At block 640, the determined transformer(s) can be implemented in the electric motor. For example, the input of the transformer can be connected between the winding neutral point 324 and the chassis 302, as shown in FIG. 3A. In other examples, the two transformers can be implemented in the electric motor, as described in FIG. 5.

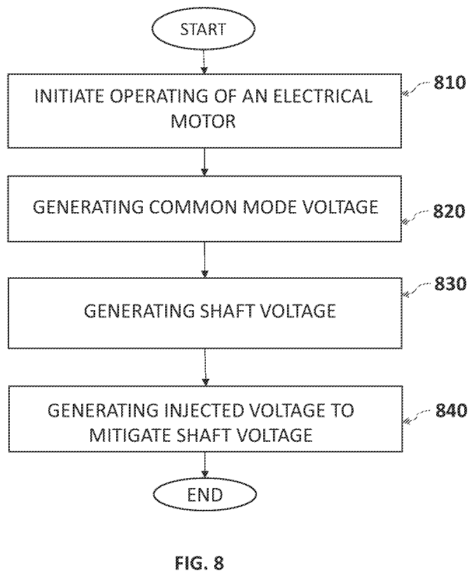

FIG. 8 illustrates an example of operating an electric motor, as described in FIGS. 3A and 3B. The electric motor can implement circuitry configured to generate injected voltage to mitigate the shaft voltage of the electric motor.

At block 810, the electric motor initiates operation. The electric motor receives input energy from an inverter, such as inverter 150 shown in FIG. 1. In some embodiments, alternating currents (AC) can be applied to the winding coil 112 included in the stator 104, and the winding coil 112 can generate a magnetic field due to the received AC. The AC is generated from an inverter, such as the switching inverter. For example, the inverter receives direct current (DC) from an external power source, such as a battery, and converts the DC into the AC by switching the DC (e.g., turning on or off the DC) in various frequencies. Thus, the switching mechanism of the inverter can generate AC waveforms in various frequencies and phases, and the speed of electric motor rotation (e.g., rotor rotation) can be modulated by adjusting the frequency of the supplied AC.

At block 820, the operation of the electric motor generates common mode voltage. The common mode voltage can be caused by the inverter when performing switching operation. For example, as described in FIG. 4B, the common mode voltage 452 is generated at the winding neutral point 324 (shown in FIG. 3A).

At block 830, the operation of the electric motor generates shaft voltage. As described in FIG. 4A, the shaft voltage 420 can be a fraction of the common mode voltage 422.

At block 840, the operation of the electric motor generates injected voltage. In some embodiments, the circuitry can include one or more transformers. In some embodiments, the transformer 314 (shown in FIG. 3A) can be configured to generate the injected voltage, as shown in FIG. 3B. The injected voltage can be configured to mitigate the shaft voltage, such as the injected voltage has opposite polarity from the shaft voltage, thus, the shaft voltage can be mitigated. The transformer can be designed based on this required injected voltage. In some embodiments, a single transformer can be implemented to generate the injected voltage. In some embodiments, multiple transformers can be implemented to reduce the form factor having a wide bandwidth. The example of implementing two transformers is described in FIG. 5.

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C,” “one or more of A, B, and C,” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

1. An electric motor assembly comprising:
a chassis;
a stator configured to receive energy from external energy sources;
a winding coil configured to generate magnetic field, wherein the winding coil is implemented within the stator;
a rotor magnetically coupled with the stator;
a shaft connected with the rotor;
bearings connected between the shaft and the chassis;
a conductor capacitively coupled with the rotor; and
a circuitry configured to generate an injected voltage, wherein the circuitry is connected with the winding coil and the conductor.

2. The electric motor assembly of claim 1, wherein the rotor is rotating by the magnetic field generated from the winding coil.

3. The electric motor assembly of claim 1, wherein the energy is received from an invertor and configured to supply an alternating current to the electric motor assembly, and wherein the alternating current comprises three waveforms with a same frequency.

4. The electric motor assembly of claim 3, wherein each waveform has 120-degree different phase.

5. The electric motor assembly of claim 1, wherein the circuitry includes a transformer, wherein the transformer is configured to generate injected energy by receiving current from a winding neutral point.

6. The electric motor assembly of claim 1, wherein the electric motor includes parasitic capacitances between the chassis and winding coil, the winding coil and the rotor, the stator and the rotor, and across the bearing, and wherein common mode voltage generates a shaft voltage between the shaft and the chassis.

7. The electric motor assembly of claim 6, wherein the shaft voltage is mitigated by the injected voltage.

8. The electric motor assembly of claim 1, wherein the circuitry comprises a first transformer, a second transformer, a low-pass filter, and a high-pass filter, and wherein the first transformer is configured to transfer high-frequency band signal by receiving an energy from the conductor and filtering the energy via the high-pass filter, and wherein the second transformer is configured to transform low-frequency band signal by receiving the energy from a winding neutral point and feeding the energy to the conductor.

9. The electric motor assembly of claim 1, wherein the electric motor assembly is implemented in an electric vehicle.

10. An electric motor assembly comprising:
a chassis;
a stator configured to receive energy from external energy sources;
a winding coil configured to generate magnetic field, wherein the winding coil is implemented within the stator;
a rotor magnetically coupled with the stator;
a shaft connected with the rotor;
bearings connected between the shaft and the chassis;
a conductor capacitively coupled with the rotor; and
one or more transformers configured to generate an injected voltage, wherein the transformer is connected with the winding coil and the conductor.

11. The electric motor assembly of claim 10, wherein the transformers are integrated in a top side of a printed circuit board (PCB), and wherein the conductor is integrated a bottom side of the PCB.

12. The electric motor assembly of claim 11, wherein the transformers receives energy from a winding neutral point.

13. The electric motor assembly of claim 10, wherein the electric motor includes parasitic capacitances between the chassis and winding coil, the winding coil and the rotor, the stator and the rotor, and across the bearing, and wherein shaft voltage is generated from one or more of the parasitic capacitances.

14. The electric motor assembly of claim 13, wherein the shaft voltage is mitigated by the injected voltage.

15. (canceled)

16. The electric motor assembly of claim 10, wherein the received energy is an alternating current, and wherein the alternating current comprising three waveforms with a same frequency.

17. The electric motor assembly of claim 16, wherein each waveform has 120-degree different phase.

18. The electric motor assembly of claim 16, wherein the frequency is a switching frequency of an inverter configured to supply AC to the electric motor assembly.

19. The electric motor assembly of claim 10, wherein the transformers are connected to a winding neutral point.

20. The electric motor assembly of claim 10, wherein a distance between the conductor and the rotor is determined based on parasitic capacitances.

21. A method for mitigating EIBD of an electric motor, the method comprising:
initiating operation of the electric motor, wherein the electric motor is initiated by receiving input at phases of the electric motor;
generating a common mode voltage;
generating a shaft voltage, wherein the shaft voltage is a fraction of the common mode voltage; and
generating injected voltage to mitigate the shaft voltage, wherein the injected voltage is generated from a transformer connected between a winding neutral point and a conductor of the electric motor, wherein an input of the transformer receives input signal from the winding neutral point, wherein an output of the transformer is connected to the conductor placed apart from a rotor, and wherein the input and output of the transformer have opposite polarity.

22.-25. (canceled)
